(19) United States
(12) Patent Application Publication
(10) Pub. No.: US 2021/0274714 A1
(43) Pub. Date: Sep. 9, 2021

(54) BUSH CUTTING SYSTEM AND BUSH CUTTING METHOD

(71) Applicant: TOYOTA JIDOSHA KABUSHIKI KAISHA, Toyota-shi (JP)

(72) Inventor: Kazuo SUYAMA, Mitaka-shi (JP)

(73) Assignee: TOYOTA JIDOSHA KABUSHIKI KAISHA, Toyota-shi (JP)

(21) Appl. No.: 17/110,370

(22) Filed: Dec. 3, 2020

(30) Foreign Application Priority Data
Mar. 4, 2020 (JP) 2020-037180

(51) Int. Cl. A01D 67/00; A01D 34/00; B65H 75/44; A01D 34/835

(52) U.S. Cl. CPC A01D 67/00; A01D 34/835; B65H 75/4484; A01D 34/008

(57) ABSTRACT

A bush cutting system includes a plurality of support posts, a cable supported by the support posts, a winding device operable to wind the cable, a lifting and lowering device that is connected to the cable, and is movable in the air when the winding device winds the cable, and a bush cutting device that is hung from the lifting and lowering device, and cuts plants.

### CROSS-REFERENCE TO RELATED APPLICATION

This application claims priority to Japanese Patent Application No. 2020-037180 filed on Mar. 4, 2020, incorporated herein by reference in its entirety.

### BACKGROUND

### 1. Technical Field

The disclosure relates to a technology for cutting plants by use of cables.

### 2. Description of Related Art

Japanese Unexamined Patent Application Publication No. 2006-067918 (JP 2006-067918 A) discloses a lawn mower in which a power source is mounted in an upper part of a cutter housing, and an output shaft of the power source protrudes substantially vertically in the cutting housing, while a lower cutter blade is mounted to a distal end of the output shaft, and an upper cutter blade is mounted to the output shaft, upward of the lower cutter blade. The lawn mower is operable to rotate the upper and lower cutter blades substantially horizontally in the cutter housing.

### SUMMARY

In the forestry industry, underbrush cutting operation is performed over about five years after saplings are planted, so that growth of the saplings is not hindered by weeds, etc. that deprive the saplings of light and water. The underbrush cutting operation is performed once or more in severely hot summer, and it requires enormous labor for a worker to climb a mountain slope while driving a bush cutter.

This disclosure provides a technology for reducing the labor required for underbrush cutting operation.

A bush cutting system according to one aspect of the disclosure includes a plurality of support posts, a cable supported by the support posts, a winding device operable to wind the cable, a lifting and lowering device that is connected to the cable, and is movable in the air when the winding device winds the cable, and a bush cutting device that is hung from the lifting and lowering device, and is configured to cut plants.

Another aspect of the disclosure is concerned with a bush cutting method. The method uses a bush cutting system including a winding device operable to wind a cable supported by a plurality of support posts, a lifting and lowering device that is connected to the cable, and is movable in the air when the winding device winds the cable, and a bush cutting device that is hung from the lifting and lowering device. The bush cutting method includes the steps of: obtaining positional information of a sapling, deriving a movement path of the bush cutting device used for cutting plants around the sapling, based on a position of the sapling, and driving the winding device and the lifting and lowering device based on the derived movement path, to move the bush cutting device and cause the bush cutting device to cut the plants.

According to the disclosure, it is possible to provide a technology for reducing the burden on workers in the process of underbrush butting operation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view useful for describing a cable use system;

FIG. 2 is a view useful for describing underbrush cutting operation using the cable use system of FIG. 1;

FIG. 3 is a view useful for describing the configuration of a bush cutting device;

FIG. 4 is a view useful for describing the functional configuration of the cable use system; and

FIG. 5A to FIG. 5C are views useful for describing a cable use system of a modified example.

### DETAILED DESCRIPTION OF EMBODIMENTS

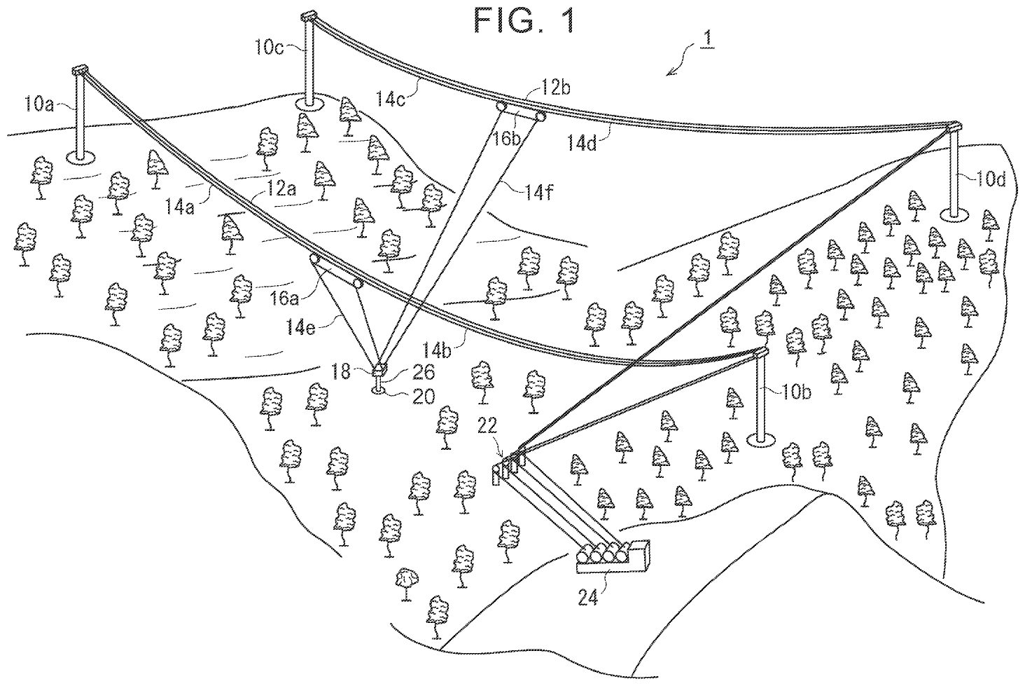

FIG. 1 shows a cable use system 1. The cable use system 1 includes a first support post 10a, second support post 10b, third support post 10c, fourth support post 10d (each of which will be called “support post 10” when they are not distinguished from one another), first main cable 12a, second main cable 12b (each of which will be called “main cable 12” when they are not distinguished from each other), first operation cable 14a, second operation cable 14b, third operation cable 14c, fourth operation cable 14d, fifth operation cable 14e, sixth operation cable 14f (each of which will be called “operation cable 14” when they are not distinguished from one another), first moving device 16a, second moving device 16b (each of which will be called “moving device 16” when they are not distinguished from each other), lifting and lowering device 18, bush cutting device 20, guide pulleys 22, winches 24, and wire 26.

The cable use system 1 is a so-called H-shaped cable use system, and is used in the forestry industry in the woods. In this embodiment, the cable use system 1 is used for tree planting and underbrush cutting, among steps of the forestry process, but may be used for transportation of trees. The use of the cable use system 1 makes it possible to remotely carry out operation required in the forestry industry.

The four support posts 10 are erected at positions that are suitable for installation and determined based on the arrangement of standing trees and the position of a tree collection place. The size of each support post 10 is set to about 5 meters to 10 meters, depending on the size of the cable use system 1, for example.

The main cables 12 and operation cables 14 are fixed as cables to the support posts 10, or are looped around pulleys of the support posts 10. The first main cable 12a is fixed to the first support post 10a and the second support post 10b, and the second main cable 12b is fixed to the third support post 10c and the fourth support post 10d. The first main cable 12a and second main cable 12b, which function as rails in the air, are installed so as not to intersect with each other. The length of each main cable 12 is about 300 meters to 1500 meters.

The operation cables 14 function as movable cables that are wound by the moving devices 16 or winches 24. The first operation cable 14a, second operation cable 14b, third operation cable 14c, and fourth operation cable 14d engage with the pulleys provided on the support posts 10, and one end of each operation cable 14 is connected to the corresponding moving device 16, while the other end is connected to the corresponding winch 24. The first operation cable 14a is connected from the winch 24 to the first moving device 16a via the second support post 10b and the first support post 10a. The second operation cable 14b is connected from the winch 24 to the first moving device 16a via the second support post 10b. The third operation cable 14c is connected from the winch 24 to the second moving device 16b via the fourth support post 10d and the third support post 10c. The fourth operation cable 14d is connected from the winch 24 to the second moving device 16b via the fourth support post 10d. The fifth operation cable 14e and sixth operation cable 14f are connected to the moving devices 16 and the lifting and lowering device 18.

The first moving device 16a and second moving device 16b are supported by the first main cable 12a and second main cable 12b, respectively, and are movable along the first main cable 12a and second main cable 12b. The first operation cable 14a, second operation cable 14b, and fifth operation cable 14e are connected to the first moving device 16a, and the third operation cable 14c, fourth operation cable 14d, and sixth operation cable 14f are connected to the second moving device 16b. The fifth operation cable 14e connects the first moving device 16a with the lifting and lowering device 18, and the sixth operation cable 14f connects the second moving device 16b with the lifting and lowering device 18. The moving devices 16 function to wind and unwind the fifth operation cable 14e and the sixth operation cable 14f, according to command signals wirelessly transmitted thereto.

The lifting and lowering device 18 hangs the bush cutting device 20 at its distal end by means of the wire 26 for lifting and lowering. The lifting and lowering device 18 moves the bush cutting device 20 up and down by winding the wire 26.

The guide pulleys 22 change the directions of the operation cables 14 looped around the guide pulleys 22. The winches 24 function to wind the operation cables 14, respectively, and have drums and drive sources for winding or unwinding the respective operation cables 14.

Operation of the cable use system 1 will be described. The winches 24 wind one of the first operation cable 14a and the second operation cable 14b and unwind the other, so as to move the first moving device 16a along the first main cable 12a. Also, the winches 24 wind one of the third operation cable 14c and the fourth operation cable 14d and unwind the other, so as to move the second moving device 16b along the second main cable 12b. As a result, the lifting and lowering device 18 is displaced along the main cables 12.

When the moving devices 16 wind one of the fifth operation cable 14e and the sixth operation cable 14f and unwind the other, the lifting and lowering device 18 moves between the first moving device 16a and the second moving device 16b. In this manner, the lifting and lowering device 18 moves in substantially horizontal directions, within a region surrounded by the four support posts 10.

Thus, the winches 24 and moving devices 16 function as a winding device capable of winding cables. The winding device winds the operation cables 14 (cables), so that the lifting and lowering device 18 and the bush cutting device 20 can move in the air in substantially horizontal directions. While the moving devices 16 that wind the fifth operation cable 14e and the sixth operation cable 14f are connected to the main cables 12 in the cable use system 1 shown in FIG. 1, the disclosure is not limited to this arrangement, but the fifth operation cable 14e and the sixth operation cable 14f may be extended to the position of the winches 24, so that the winding function of the moving devices 16 can be integrated with that of the winches 24. Thus, the winding device may be an integrated system, or may consist of separate elements.

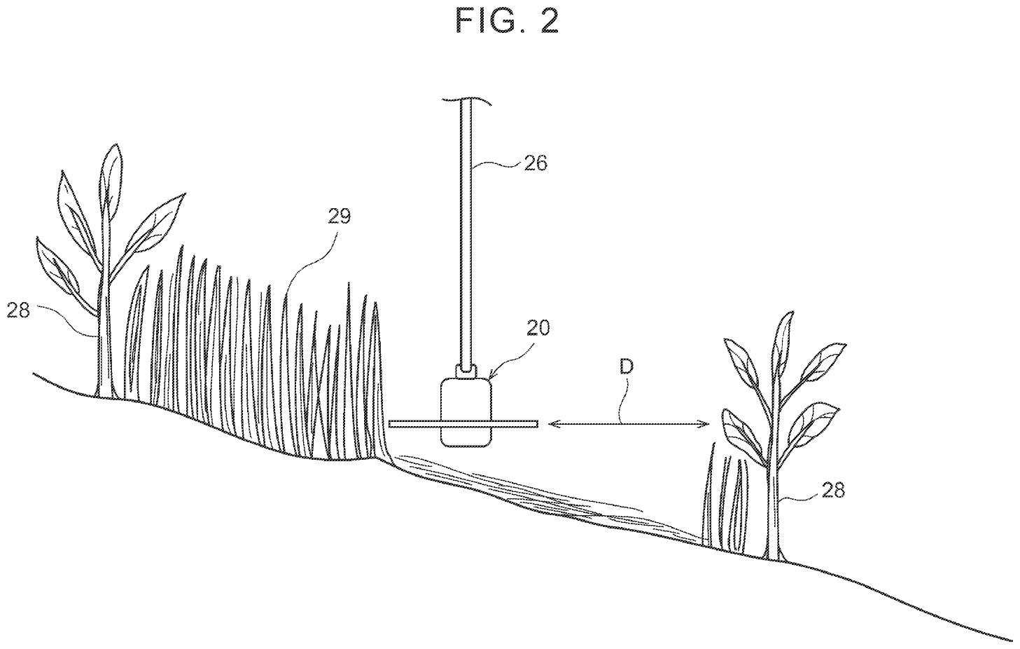

FIG. 2 illustrates underbrush cutting operation using the cable use system 1. The underbrush cutting is carried out in summer, over about five years after tree planting, so as to remove plants 29, such as weeds and bamboo grass, which would hinder growth of saplings 28 planted. With the underbrush cutting thus performed, the saplings 28 can be sufficiently supplied with light and water, and are able to grow with stability.

The saplings 28 are planted at intervals of about 1.5 meters to 3 meters, and the plants 29 grow between the saplings 28. The bush cutting device 20 is lowered by the lifting and lowering device 18 down to the vicinity of the ground, and is driven to cut the plants 29 around the saplings 28. Although details will be described later, the bush cutting device 20 is moved along the ground, under control of a control device, so as to avoid the saplings 28. The control device moves the bush cutting device 20, based on a distance D between the bush cutting device 20 and the sapling 28 concerned, and causes the bush cutting device 20 to cut the plants 29 around the bush cutting device 20. Thus, the cable use system 1 functions as a bush cutting system that performs underbrush cutting operation.

With the underbrush cutting operation thus automatically performed, it is possible to reduce labor as compared with the case where the work is done by humans. Also, accidents that would occur when a worker falls down during underbrush cutting, or the brush cutting device bounces against a rock, can be avoided. Also, the number of times of underbrush cutting operation can be easily increased, which makes it possible to do cutting as many times as desired before the plants 29 grow high, so that the growth of the sapling 28 can be stabilized. Since the plants 29 are cut off before they grow high, the sapling 28 and the plants 29 can be easily distinguished from each other.

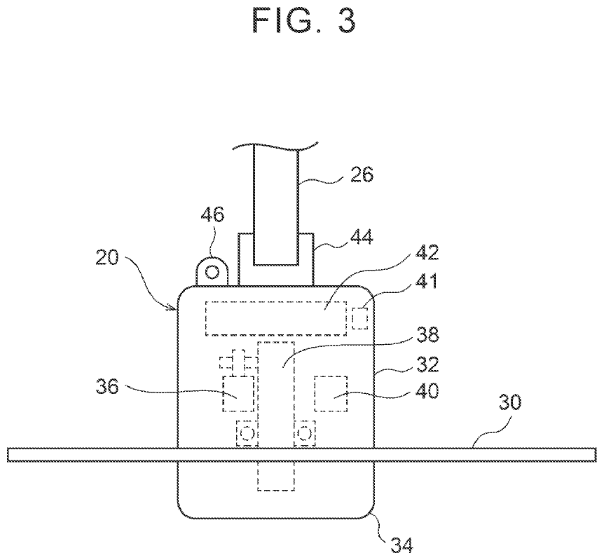

FIG. 3 shows the configuration of the bush cutting device 20. The bush cutting device 20 has a cutter 30, upper unit 32, lower unit 34, mounting portion 44, and imaging unit 46. The upper unit 32 has a motor 36, shaft 38, and power supply 40. Also, the upper unit 32 houses a contact restricting device 42.

The mounting portion 44 is provided on an upper end face of the upper unit 32, and is used for mounting the bush cutting device 20 to the wire 26. With the mounting portion 44, the bush cutting device 20 is detachably connected to the wire 26. The imaging unit 46 captures an image of the vicinity of the bush cutting device 20, and sends the captured image to the control device.

The cutter 30 is formed in a disc-like shape, and is rotatable. A hole through which the shaft 38 is inserted is formed in the middle of the cutter 30. The shaft 38 is rotatably supported by the upper unit 32, and joins to the cutter 30. When the shaft 38 rotates about its axis., the cutter 30 is rotated. The shaft 38 extends through the cutter 30, and is connected to the lower unit 34.

The motor 36 rotates the shaft 38 about its axis. The power supply 40 supplies electric power to the motor 36, oscillation detector 41, and contact restricting device 42. While the motor is a drive source of the cutter 30 in this embodiment, the drive source is not limited to the motor, but may be an engine driven by use of oil.

The lower unit 34 connects to the shaft 38, such that the cutter 30 is sandwiched by and between the upper unit 32 and the lower unit 34. The lower unit 34 can be detached from the shaft 38, and is detached upon replacement of the cutter 30.

The oscillation detector 41 detects oscillation of the bush cutting device 20. The oscillation detector 41 may be a two-dimensional acceleration sensor or three-dimensional acceleration sensor, or may be a motion sensor that detects motion of the bush cutting device 20. Also, the oscillation detector 41 may detect positional information of the bush cutting device 20, using a global positioning system (GPS), and detect oscillation of the bush cutting device 20, based on change of the positional information of the bush cutting device 20, or may detect oscillation of the bush cutting device 20, using a difference between the positional information of the bush cutting device 20 and positional information of the lifting and lowering device 18.

The contact restricting device 42 is driven based on the detection result of the oscillation detector 41, to restrict contact of the bush cutting device 20 with saplings. The contact restricting device 42 operates to stabilize the posture of the bush cutting device 20 based on the detection result of the oscillation detector 41, and applies reaction force in such a direction as to curb oscillation of the bush cutting device 20. The contact restricting device 42 may be a disc that has a tiltable axis of rotation and can rotate to generate the gyroscopic moment, or a gas jetting device that ejects gas, or a combination thereof.

In a modified example, the contact restricting device 42 may perform control for restricting contact of the bush cutting device 20 with saplings, based on the detection result of the oscillation detector 41 and the positional information of the saplings. The contact restricting device 42 may be provided on the lifting and lowering device 18 side, and may apply reaction force against oscillation, to the wire 26, so as to curb oscillation of the bush cutting device 20. Also, the contact restricting device 42 may be a winding device, which moves the lifting and lowering device 18 away from the saplings, so as to restrict contact of the bush cutting device 20 with the saplings.

Also, the contact restricting device 42 may be provided on the lower unit 34, in the form of legs that can contact the ground. The contact restricting device 42 can extend toward and retract from the ground, and may extend toward the ground, and contact the ground so as to curb oscillation of the bush cutting device 20, when oscillation of the bush cutting device 20 becomes equal to or larger than a predetermined value.

While the contact restricting device 42 is housed in the upper unit 32 in this embodiment, the disclosure is not limited to this arrangement, but the contact restricting device 42 may be provided outside the upper unit 32. Namely, the contact restricting device 42 may be provided integrally with the bush cutting device 20, or may be provided separately from the bush cutting device 20.

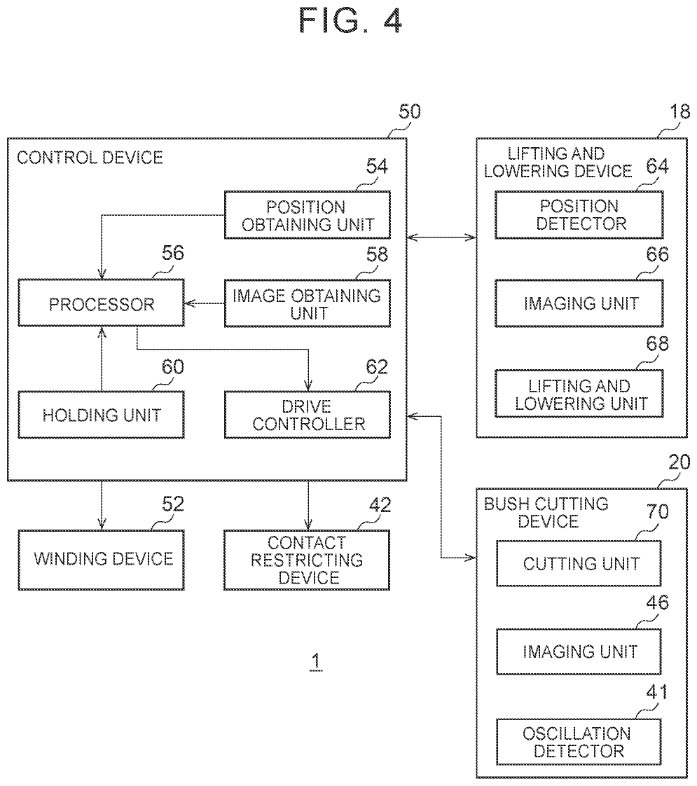

FIG. 4 shows the functional configuration of the cable use system 1. In FIG. 4, each element described as one of function blocks that perform various operations can be constructed in terms of hardware by a circuit block, memory or other LSI, and is implemented in terms of software by a program loaded into a memory. Thus, it is to be understood by those skilled in the art that the function blocks can be implemented in various forms via only hardware, only software, or a combination thereof, and are not limited to any of these forms.

The control device 50 performs control when the bush cutting device 20 cuts plants around saplings. The control device 50 is wirelessly connected to the lifting and lowering device 18, bush cutting device 20, contact restricting device 42, and winding device 52, and is able to control each of these devices. The control device 50 has a position obtaining unit 54, processor 56, image obtaining unit 58, holding unit 60, and drive controller 62. The lifting and lowering device 18 has a position detector 64, imaging unit 66, and lifting and lowering unit 68. The bush cutting device 20 has a cutting unit 70, imaging unit 46, and oscillation detector 41.

The position detector 64 of the lifting and lowering device 18 detects positional information of the lifting and lowering device 18, using the GPS, and sends the positional information to the control device 50. A time stamp is given to the positional information. The imaging unit 66 captures an image below the lifting and lowering device 18, and sends the captured image of the bush cutting device 20 and its vicinity to the control device 50. The control device 50 can detect an oscillating condition of the bush cutting device 20. The lifting and lowering unit 68 winds and unwinds the wire 26, thereby to move the bush cutting device 20 up and down.

The cutting unit 70 of the bush cutting device 20 consists of the cutter 30, motor 36, shaft 38, and so forth, and is able to cut plants.

The position obtaining unit 54 of the control device 50 obtains positional information of the lifting and lowering device 18. The position obtaining unit 54 may obtain positional information of the bush cutting device 20, in addition to that of the lifting and lowering device 18. The image obtaining unit 58 obtains captured images from the lifting and lowering device 18 and the bush cutting device 20.

The holding unit 60 holds positional information of saplings and ground information in advance. The positional information of saplings and the ground information may be generated based on images captured at the time of planting of the saplings. For example, the imaging unit 46 may capture an image or images of a region inside the support posts 10 after the saplings are planted, and analyze the captured image(s), to generate the positional information of the saplings and the ground information. The ground information may be altitude information, or may be a level as measured in the vertical direction of the ground, and is associated with the positional information. Since weeds are cut and removed when saplings are planted, the ground information can be easily obtained. The ground information may include information on positions of obstacles, such as stubs and rocks.

The holding unit 60 may obtain positional information of saplings and ground information from an external server device. Also, the processor 56 may calculate positional information of saplings based on the positional information of the bush cutting device 20, and sapling image included in the captured image of the bush cutting device 20, and the holding unit 60 may hold the calculated positional information of saplings.

The processor 56 derives a movement path of the bush cutting device for cutting plants around the saplings, based on the positional information of the saplings. For the movement path, a start point and an end point are set, and the movement path is set so that the bush cutting device is spaced from the saplings by a predetermined distance or larger, and is set based on the diameter of the cutter 30, so that the cutter 30 passes through the entire area of the region excluding the saplings. The start point and end point of the movement path may be set to a middle point between one sapling and another sapling. Also, the movement path may include information on the level of the ground.

The processor 56 may correct the movement path of the bush cutting device 20 based on the captured image of the imaging unit 46, during the actual movement control of the bush cutting device 20. When the positional information of saplings calculated from the captured image of the imaging unit 46 and the positional information of the bush cutting device 20 is different from the positional information of the saplings held by the holding unit 60, the processor 56 corrects the movement path according to the calculated amount of difference. Thus, the movement path derived based on the sapling information held by the holding unit 60 can be corrected based on the actual captured image. Also, the processor 56 may adjust the movement path so as to avoid obstacles, such as stubs and rocks, based on the captured image of the imaging unit 46. Thus, it is possible to reduce a possibility that the cutter 30 hits against a stub or rock, and the bush cutting device 20 oscillates.

The drive controller 62 performs control to drive the winding device 52 and the lifting and lowering device 18 to move the bush cutting device 20, based on the movement path derived by the processor 56, and drive the bush cutting device 20 to cut plants. The drive controller 62 starts driving the bush cutting device 20 at the start point of the movement path, and causes the lifting and lowering device 18 to lower the bush cutting device 20. Then, the drive controller 62 controls the lifting and lowering device 18 according to the level of the ground, while controlling the winding device 52 and moving the bush cutting device 20 along the movement path, and stops driving the bush cutting device 20 at the end point. Also, the lifting and lowering device 18 changes the level of the bush cutting device 20, based on the level information of the ground, so that the bush cutting device 20 moves along the ground. Thus, the bush cutting device 20 can move while avoiding saplings, and cut plants around the saplings.

The drive controller 62 may differ control of the bush cutting device 20, between a region within a short distance from a sapling, and a region within a long distance from the sapling. The drive controller 62 sets a limit to driving of the bush cutting device 20 so as not to cut the sapling in the region within a short distance from the sapling, and does not set a limit to driving of the bush cutting device 20 in the region within a long distance from the sapling. Where saplings are spaced at intervals of 2 meters, for example, the region within a short distance from one sapling means a range within 50 cm from the sapling, and the region within a long distance from the sapling means a range that is spaced 50 cm or larger apart from the sapling. Thus, in the region defined by the support posts 10, regions where driving of the bush cutting device 20 is inhibited, short-distance regions where driving of the bush cutting device 20 is restricted, and long-distance regions where driving of the bush cutting device 20 is not restricted, are set.

When the oscillation detector 41 detects oscillation of a predetermined threshold value or larger in the short-distance region, driving of the bush cutting device 20 is stopped. In the long-distance region, on the other hand, driving is not stopped even when the bush cutting device 20 oscillates. Also, in the short-distance region, the moving speed of the bush cutting device 20 may be controlled to be slower than that in the long-distance region. Thus, the drive controller 62 carefully controls the bush cutting device 20 in the short-distance region, so as to reduce a possibility that the bush cutting device 20 cuts a sapling. In this connection, each sapling may be provided with an IC tag, and the bush cutting device 20 may be provided with a short-range wireless communication device for detecting the IC tag, so that the device can detect a sapling in a short distance or range.

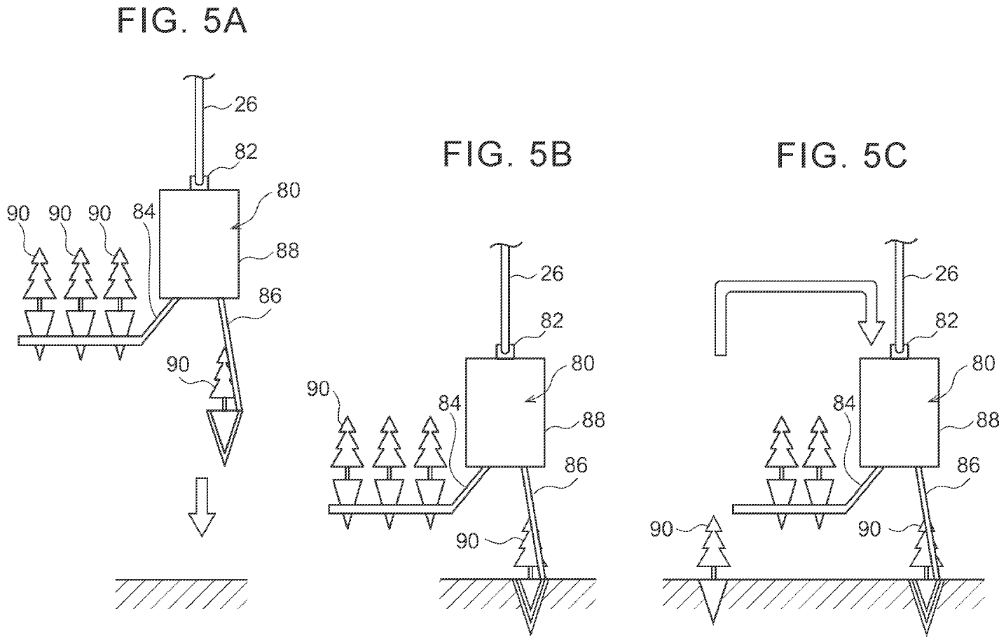

FIG. 5A to FIG. 5C illustrate a cable use system 1 according to a modified example. The cable use system 1 of the modified example is different from that of the illustrated embodiment in that an actuator hung from the lifting and lowering device 18 is not the bush cutting device 20, but a tree planting device 80. Namely, the cable use system 1 of the modified example performs tree planting operation under remote control.

The tree planting device 80 has a mounting portion 82, loading portion 84, planting portion 86, and main body 88. The mounting portion 82 is provided on an upper end face of the main body 88, and is used for mounting the tree planting device 80 to the wire 26. With the mounting portion 82, the tree planting device 80 is detachably connected to the wire 26.

The loading portion 84 holds a plurality of container seedlings 90. Each of the container seedlings 90 can be planted when inserted into a hole of a given shape formed in the ground, because the shape of roots is kept being the same as that of a rootball. The planting portion 86 can receive the container seedling 90 from the loading portion 84, and plants the container seedling 90 in the ground. The planting portion 86 forms a hole of a given shape, into which the container seedling 90 is to be inserted, in the ground. The tree planting device 80 may be provided with a dibbling mechanism, separately from the planting portion 86.

The main body 88 has a drive source that transfers the container seedlings 90 from the loading portion 84 to the planting portion 86, a camera that captures an image of the vicinity of the tree planting device 80, and a laser sensor that measures the distance from the tree planting device 80 to the ground, i.e., the level of the tree planting device 80 from the ground. The image captured by the main body 88 and the detection result of the distance from the ground are sent to the control device 50.

The control device 50 moves the tree planting device 80, and performs control for executing tree planting. The processor 56 of the control device 50 derives a position at which the container seedling 90 is received, and derives a movement path of the tree planting device 80 that moves to the position where the container seedling 90 is received.

In FIG. 5A, the drive controller 62 drives the winding device 52 based on the derived movement path, so that the tree planting device 80 moves to the planting position of the container seedling 90. The drive controller 62 drives the lifting and lowering device 18 to lower the tree planting device 80 until it hits the ground, at the planting position of the container seedling 90.

FIG. 5B shows how the planting portion 86 plants the container seedling 90. Then, the lifting and lowering device 18 lifts the tree planting device 80, and the winding device 52 moves the tree planting device 80 to the next planting position.

FIG. 5C shows how the lifting and lowering device 18 lowers the tree planting device 80 down to the ground at the next planting position, and the planting portion 86 plants the next container seedling 90. Thus, the use of the cable use system 1 makes it possible to plant the container seedlings 90 at the planting positions derived in advance.

When the processor 56 analyzes a captured image of a camera provided on the tree planting device 80, and detects an obstacle, such as a rock or a stub, at a planting position, the processor 56 may decide to avoid planting at the planting position, and decide to move the tree planting device 80 to the next planting position. It is thus possible to reduce a possibility that the tree planting device 80 collides with an obstacle and is damaged.

Thus, the cable use system 1 can implement two or more functions, by replacing a device hung from the lifting and lowering device 18 with another device. Thus, the convenience of the cable use system 1 can be improved, and the support posts 10 and cables can be effectively used.

The disclosure has been described based on the embodiment. It is to be understood by those skilled in the art that the embodiment is merely exemplary, that the embodiment may have modified examples with various combinations of constituent elements and operation processes, and that the modified examples are also within the scope of the disclosure.

While the bush cutting device 20 is hung from the lifting and lowering device 18 with the wire 26 in the illustrated embodiment, the disclosure is not limited to this arrangement. For example, the bush cutting device 20 may be hung with a rigid rod member. The rod member may have a rack gear having a tooth portion formed on its side face, and may mesh with the lifting and lowering device 18. In this case, the lifting and lowering device 18 has a pinion gear that meshes with the rod member, and lifts and lowers the bush cutting device 20 by rotating the pinion gear. Thus, the bush cutting device 20 is hung with the rigid rod member, so that oscillation of the bush cutting device 20 can be reduced.

While the cable use system 1 is of the H-shaped type in the illustrated embodiment, the cable use system 1 is not limited to this shape, but the number of the support posts 10 may be three, for example. Also, while the H-shaped cable use system 1 is illustrated, the shape of the cable use system 1 is not specified as the H-shape. For example, the cable use system 1 may be an X-shaped system having four support posts, and cables that are arranged in a cross shape.

What is claimed is:

1. A bush cutting system comprising:
a plurality of support posts;
a cable supported by the support posts;
a winding device operable to wind the cable;
a lifting and lowering device that is connected to the cable, and is movable in the air when the winding device winds the cable; and
a bush cutting device that is hung from the lifting and lowering device, and is configured to cut plants.

2. The bush cutting system according to claim 1, further comprising a control device that controls movement of the bush cutting device, wherein:
the control device has a holding unit that holds positional information of a sapling, and a drive controller configured to drive the winding device and the lifting and lowering device and move the bush cutting device; and
the drive controller is configured to move the bush cutting device and cause the bush cutting device to cut the plants around the sapling.

3. The bush cutting system according to claim 1, further comprising:
an oscillation detector configured to detect oscillation of the bush cutting device; and
a contact restricting device configured to restrict contact of the bush cutting device with a sapling, based on a detection result of the oscillation detector.

4. A bush cutting method using a bush cutting system including a winding device operable to wind a cable supported by a plurality of support posts, a lifting and lowering device that is connected to the cable, and is movable in the air when the winding device winds the cable, and a bush cutting device that is hung from the lifting and lowering device, the bush cutting method comprising:
obtaining positional information of a sapling;
deriving a movement path of the bush cutting device used for cutting plants around the sapling, based on a position of the sapling; and
driving the winding device and the lifting and lowering device based on the derived movement path, to move the bush cutting device and cause the bush cutting device to cut the plants.
